(19) United States
(12) Patent Application Publication
(10) Pub. No.: US 2010/0042379 A1
(43) Pub. Date: Feb. 18, 2010

(54) Framework to Determine the Capacity of A Structure

(76) Inventors: Karel Minnaar, Houston, TX (US); Paulo C. Gioielli, Houston, TX (US); Mario L. Macia, Bellaire, TX (US); Pakal Rahul, Pearland, TX (US); Francois C. Bardi, Sugar Land, TX (US)

Correspondence Address: Exxon Mobil Upstream;Research Company, P.O. Box 2189, (CORP-URC-SW 359), Houston, TX, 77252-2189, US

(21) Appl. No.: 12/525,495

(22) PCT Filed: Feb. 8, 2008
(86) PCT No.: PCT/US08/01753

§ 371 Date: Jul. 31, 2009

Related U.S. Application Data
(60) Provisional application No. 60/919,053, filed on Mar. 20, 2007.

(51) Int. Cl. G06F 17/50; G06F 17/10; G06G 7/50

(52) U.S. Cl. 703/1; 703/2; 703/9

(57) ABSTRACT

A framework for determining or predicting the capacity of a structure. The framework includes predicting the capacity of the structure utilizing a physics-based prediction model. The prediction model may be constructed from a variety of numerical analysis approaches. The prediction model further incorporates at least one material physics process, at least one geometry description, and at least one limit state. The limit states may include collapse, tensile fracture, and buckling. The framework calls for validation of the predicted capacity of the structure via experimental verification or other methods. In some embodiments, the structure is a pipeline for producing hydrocarbons and the modes of operation may include parametric studies, Monte-Carlo type distributions, or stand-alone values.

### CROSS REFERENCE TO RELATED APPLICATIONS

This application claims the benefit of U.S. Provisional Application No. 60/919,053, filed Mar. 20, 2007.

This application is related to U.S. Provisional Application No. 60/918,999 titled “Method to Measure Tearing Resistance,” filed Mar. 20, 2007.

### FIELD OF THE INVENTION

The present invention relates to determining or predicting the capacity of structures. More particularly, the present invention relates to apparatuses and methods to measure and predict strain capacity of a welded structure, such as a pipeline having a flaw, utilizing a framework based on a physics-based prediction model.

### BACKGROUND

This section is intended to introduce the reader to various aspects of art, which may be associated with exemplary embodiments of the present invention, which is described and/or claimed below. This discussion is believed to be helpful in providing the reader with information to facilitate a better understanding of particular aspects of the present invention. Accordingly, it should be understood that these statements are to be read in this light, and not necessarily as admissions of prior art.

The production of hydrocarbons, such as oil and gas, has been performed for numerous years. To produce these hydrocarbons, one or more wells of a field are typically drilled into a subsurface location, which is generally referred to as a subterranean formation, basin or reservoir. From the wells, lines or pipelines are utilized to carry the hydrocarbons to a surface facility for processing or from the surface facility to other locations. These pipelines are typically formed from pipe segments that are welded together at weld joints to form a continuous flow path for various products. As such, these pipelines provide a fluid transport system for a wide variety of products, such as oil, gas, water, coal slurry, etc.

Generally, pipelines may be affected by various forces that damage or rupture the pipeline. Recently, increased demand for oil and gas has provided a significant incentive to place pipelines in challenging geographic regions such as arctic and seismic areas where the pipeline can be subjected to large ground deformations. Placing pipelines in these regions presents challenges in pipeline strength and durability that were not previously addressed in conventional pipeline designs. These large ground deformations may occur in seismic regions, such as around fault lines, or in arctic regions, such as permafrost heave/thaw related ground movements. In these regions, pipelines may be subjected to large upheaval or subsidence ground movements that occur from the ground freezing/thawing and/or large horizontal ground movements that occur from earthquake events. Because of the ground movements, pipelines, which may be above or below ground, are subject to large strains and plastic deformations that may lead to compromising the integrity or serviceability of these pipelines, which may disrupt the flow of fluids. Further, various load conditions, such as force-controlled load conditions, may be applied to the pipeline as internal pressures and external pressures. In particular, if the pipeline is subjected to predominantly force-controlled load conditions, a conventional allowable stress design methodology may be utilized to ensure that the level of stress in the pipeline remains below the yield strength of the pipeline material.

In addition, because the pipe segments are typically welded together, the weld joints between the pipe segments or between the pipe segments and auxiliary components, such as elbows or flanges, may provide weak points that are susceptible to these forces. For instance, a weld joint between two pipe segments may have flaws that weaken the pipeline. If the weld joint has flaws, then the pipeline may fail at the weld joint due to imposed load conditions or ground movements. Accordingly, the weld joints of the pipe segments are preferably designed to have sufficient strength and fracture toughness to prevent failure of the weld joint under large strains and deformations. This may be accomplished by the use of strain-based design methods involving selecting a proper weld and pipeline material and geometry and selecting an appropriate welding technique, inspection acceptance criteria, and geometry.

There exists no generally accepted method to design a welded pipeline to sustain large plastic deformations associated with design methods such as strain-based design methods. For example; various design standards or guidelines exist to determine the design limits of welded pipelines subjected to stress-based design loads. Examples include, American Society of Mechanical Engineers (ASME) standards B31.1, B31.2 and B31.3 and Det Norske Veritas (DNV) standard DNV-OS-F101. In addition, standards exist to evaluate the response of a welded structure with flaws under stress based design conditions. Examples include British Standard BS7910 and American Petroleum Institute (API) standard 579. These methods are based on a single fracture parameter (or driving force) such as the J-integral or crack tip opening displacement (CTOD) to characterize crack tip conditions and can be used as geometry-independent fracture criterion. Single parameter fracture mechanics remain valid under conditions of small scale yielding. Under conditions of large scale yielding, however single parameter fracture mechanics breaks down and two-parameter theories are required. In some cases, even two-parameter theories become invalid under large strains. ANDERSON, T. L., Fracture Mechanics: Fundamentals and Applications, 2d ed., CRC Press, Inc. (1995). In addition, the fracture parameter known to those skilled in the art as the J-integral is not a proven fracture parameter under the conditions of large scale plasticity or after significant crack growth. Therefore, known fracture mechanics methods cannot be reliably applied to assess tensile capacity at strains beyond the yield point of the material.

Due to the lack of reliable predictive methods to determine the tensile capacity of welded pipelines, extensive proof testing is typically required to validate the tensile strain capacity of a pipeline. Proof testing involves applying a load to a full size pipe until the pipe fails to validate a target strain capacity. This requires a different test to validate each proposed configuration of parameters such as pipe and weld geometry, pipe and weld strength, pipe and weld fracture toughness and flaw geometry and location. Such a proof testing approach is an expensive and time-consuming methodology to develop an acceptable strain based design and typically impacts pipeline project schedules and cost.

Accordingly, the need exists for apparatuses and methods of utilizing a framework based on analytical, computational, and experimental methods to enable efficient design of structural bodies for strain-based design conditions which would enable the structural bodies to withstand large scale yielding in the presence of large strains and deformations.

Other potentially relevant materials may be found at: GURSON, A. L., “Continuum Theory of Ductile Rupture by Void Nucleation and Growth: Part I—Yield Criteria and Flow Rules for Porous Ductile Media,” J. ENG'G. MATERIALS AND TECHNOLOGY, 99:2-15 (1977); NEEDLEMAN, A. AND TVERGAARD, V., “An Analysis of Ductile Rupture in Notched Bars,” J. MECH. PHYS. SOLIDS, 32:461-490 (1984); XU, XP, NEEDLEMAN, A., “Numerical Simulations of Fast Crack Growth in Brittle Solids,” JOURNAL OF THE MECHANICS AND PHYSICS OF SOLIDS, 42:1397-1434 (1994); CORIGLIANO, ET AL., “Identification of Gurson-Tvergaard Material Model Parameters via Kalman Filtering Technique,” INTERNATIONAL JOURNAL OF FRACTURE, 104: 349-373 (2000); CHEN AND LAMBERT, “Analysis of Ductile Tearing of Pipeline-steel in Single Edge Notch Tension Specimens,” INTERNATIONAL JOURNAL OF FRACTURE, 124: 179-199, (2003); CORNEC ET AL., “On the Practical Application of the Cohesive Model,” ENGINEERING FRACTURE MECHANICS, 70: 1963-1987 (2003); ABENDROTH, “Determination of Deformation and Failure Properties of Ductile Materials by Means of the Small Punch Test and Neural Networks, COMPUTATIONAL MATERIALS SCIENCE, 28, 633-644 (2003); SCHALBE, K-H, CORNEC, A., LIDBURY D., “Fracture Mechanics Analysis of the Bimet Welded Pipe Tests,” INT'L JOURNAL OF PRESSURE VESSELS AND PIPING, 81: 251-277 (2004); SU HAO, WING KAM LIU, BRIAN MORAN, FRANCK VERNEREY, GREGORY B. OLSON, “Multi-scale Constitutive Model and Computational Framework for the Design of Ultra-high Strength, High Toughness Steels,” COMPUT. METHODS APPL. MECH. ENG'G, 193: 1865-1908 (2004); ROBERTO BRUSCHI, ENRICO TORSELLETTI, LUIGINO VITALI, MONS HAUGE, ERIK LEVOLD, “Fracture Control—Offshore Pipeline Current Status of Fracture Assessment for Pipelines Limitations and the Need for Development,” OMAE June 12-17, Halkidiki, Greece (2005); EDS. G. AUGUSTI, G. I. SCHUELLER AND M. CIAMPOLI, “Application of the Local Approach to Fracture in the Ductile-to-brittle Transition,” SAFETY AND RELIABILITY OF ENGINEERING SYSTEMS AND STRUCTURES, Millpress, Rotterdam (2005); THAULOW, C., ØSTBY, E., et al., “Fracture Control of Pipelines Using LINKpipe” <found at http://www.linkftr.no> (April 2006); CRAVERO, S., RUGGIERI, C., “Evaluation of Crack Growth Resistance Curves for Pipeline Steels Using Constraint Designed Fracture Specimens,” IPC2006-10075 (Sep. 25-29, 2006); U.S. Pat. No. 6,267,011; U.S. Pat. No. 7,039,528; U.S. Provisional Application No. 60/918,999 titled “Method to Measure Tearing Resistance” filed on Mar. 20, 2007.

### SUMMARY OF INVENTION

One embodiment of the present invention discloses a method of determining the capacity of a structure. The method includes predicting the capacity of the structure utilizing a framework, wherein the framework comprises a physics-based prediction model, wherein the prediction model incorporates at least one material physics process, at least one geometry description, and at least one limit state; and further includes validating the predicted capacity of the structure. The structure may be a pipeline having a pipe weld, the validation may be experimental, and the capacity may be strain capacity. The capacity may be determined using one of a parametric study approach, a stand alone design analysis, and a Monte-Carlo simulation.

Another embodiment of the present invention discloses a method of predicting the capacity of a structure. The method includes providing a framework including a physics-based prediction model; and incorporating at least one material physics process, at least one geometry description, and at least one limit state into the physics-based prediction model, wherein the framework is used to predict the capacity of the structure.

A third embodiment of the present invention discloses a method of producing hydrocarbons. The method includes designing a pipeline for producing hydrocarbons. The designing includes determining the capacity of the pipeline, which includes predicting the capacity of the pipeline utilizing a framework, wherein the framework comprises a physics-based prediction model, and wherein the prediction model incorporates at least one material physics process, at least one geometry description, and at least one limit state; and validating the predicted capacity of the pipeline. The method further includes producing hydrocarbons utilizing the pipeline.

A fourth embodiment of the present invention discloses a method of designing a structure. The method includes determining a capacity of the structure, which includes predicting the capacity of the structure utilizing a framework, wherein the framework comprises a physics-based prediction model, and wherein the prediction model incorporates at least one material physics process, at least one geometry description, and at least one limit state; and validating the predicted capacity of the structure.

A fifth embodiment of the present invention discloses a structure comprising a capacity. The capacity is determined by predicting the capacity of the structure utilizing a framework, wherein the framework comprises a physics-based prediction model, and wherein the prediction model incorporates at least one material physics process, at least one geometry description, and at least one limit state; and validating the predicted capacity of the structure.

A sixth embodiment of the present invention discloses an apparatus comprising a processor and a memory coupled to the processor. The processor is configured to execute computer readable instructions to predict the capacity of a structure utilizing a framework, wherein the framework comprises a physics-based prediction model, wherein the prediction model incorporates at least one material physics process, at least one geometry description, and at least one limit state.

A seventh embodiment of the present invention discloses an apparatus comprising a processor and a memory coupled to the processor. The processor is configured to generate a physics-based prediction model utilizing at least one material physics process, at least one geometry description, at least one limit state, and at least one validation, wherein the physics-based prediction model is utilized in a framework for determining a capacity of a structure.

### BRIEF DESCRIPTION OF THE DRAWINGS

The foregoing and other advantages of the present technique may become apparent upon reading the following detailed description and upon reference to the drawings in which:

FIGS. 1A-1B are illustrations of a cross-section of a tubular having a flaw and a capacity plot or curve.

FIG. 2 is an illustration of a schematic representation of an exemplary embodiment of the framework of certain aspects of the present invention.

FIG. 3 is an illustration of a schematic representation of exemplary alternative embodiments of certain aspects of the framework of FIG. 2 of the present invention.

FIGS. 4A-4D are illustrations of an exemplary embodiment of certain aspects of the parametric study process, parameter inputs, and a capacity response surface of FIG. 3 of the present invention.

FIG. 5 is an illustration of a schematic representation of an exemplary embodiment of certain aspects the stand-alone strain capacity calculation of FIG. 3 of the present invention.

FIG. 6 is an illustration of a schematic representation of an exemplary embodiment of certain aspects of the Monte-Carlo process of FIG. 3 of the present invention.

FIG. 7 is an illustration of a schematic representation of an exemplary capacity calculation software application of FIGS. 2-6 of the present invention.

FIG. 8 is an illustration of a schematic representation of an exemplary embodiment of an automated software tool for use with the framework and models of FIGS. 2-6 of the present invention.

FIGS. 9A-9D are illustrations of test specimens and test results of an exemplary embodiment of a validation experiment of FIG. 2 of the present invention.

FIGS. 10A-10B are illustrations of exemplary results of driving force graphs obtained using an exemplary embodiment of the framework of FIG. 2.

FIG. 11A is an illustration of an exemplary prediction of the onset of unstable tearing using one embodiment of the framework of FIG. 2 of the present invention.

FIG. 11B is an illustration of an exemplary validation of the onset of unstable tearing using one embodiment of the framework of FIG. 2 of the present invention.

### DETAILED DESCRIPTION

In the following detailed description, the specific embodiments of the present invention will be described in connection with its preferred embodiments. However, to the extent that the following description is specific to a particular embodiment or a particular use of the present invention, this is intended to be illustrative only and merely provides a concise description of the exemplary embodiments. Accordingly, the invention is not limited to the specific embodiments described below, but rather, the invention includes all alternatives, modifications, and equivalents falling within the true scope of the appended claims.

The term “capacity” as used herein, refers to a physical quantity defining the maximum load, deformation, stress, strain, pressure, or temperature of a physical member before failure of that member. For example, a particular type of capacity is the “strain capacity,” which may be defined as the strain at which stable ductile tearing initiates or the strain at which unstable ductile tearing initiates.

The present invention is directed to apparatuses and methods of utilizing a framework of analytical, computational, and experimental methods to enable efficient design of structural bodies for strain-based design conditions to enable the structural bodies to withstand large scale yielding. More specifically, the present invention relates to the design and selection of welded tubulars for use in oil and gas operations.

The present invention is directed to a framework comprising: (1) identification of underlying physics controlling material behavior including identification of behaviors before, during, and after a failure mechanism is initiated (material physics processes), (2) determination of failure modes (limit states), (3) description of problem geometry and geometric features that influence structural response of failure (geometry description), (4) a physics-based prediction model that incorporates the material physics processes, limit states, and geometry description, and (5) validation of the physics-based prediction model. Together, these components make up a framework which is used to determine the capacity of a structure, such as a welded pipeline. The framework may also be used to predict capacity, which may not include the validation component. Validation may include verification of the physics-based prediction model via experimentation, or iteration of the model until the results are validated.

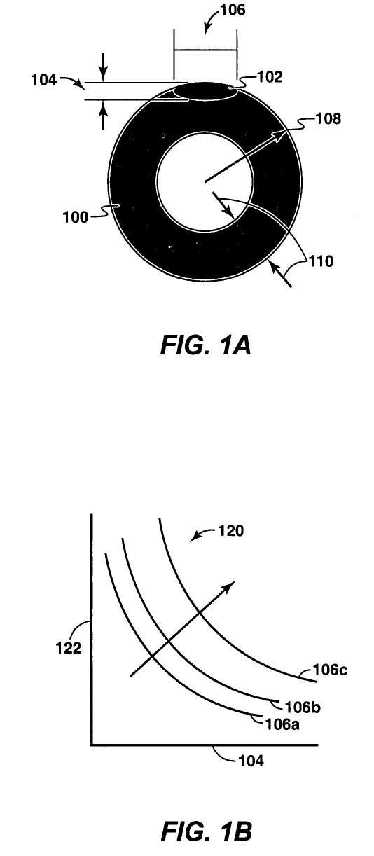

Referring now to the figures, FIGS. 1A-1B illustrate a cross-sectional view of a tubular 100 having a flaw 102 and a capacity plot or curve 120. The flaw 102 has a height 104 and a length 106. The tubular 100 has a radius 108, and a wall thickness 110. FIG. 1B illustrates a plot 120 of tensile capacity 122 versus flaw height 104 for a range of flaw lengths 106a-106c. The plot 120 does not necessarily accurately depict the relationship between capacity 122 and flaw height 104. It simply shows that the capacity 122 of a tubular with a flaw 102 is dependent upon the geometry of the flaw 102 (e.g. the flaw height 104 and flaw length 106a-106c).

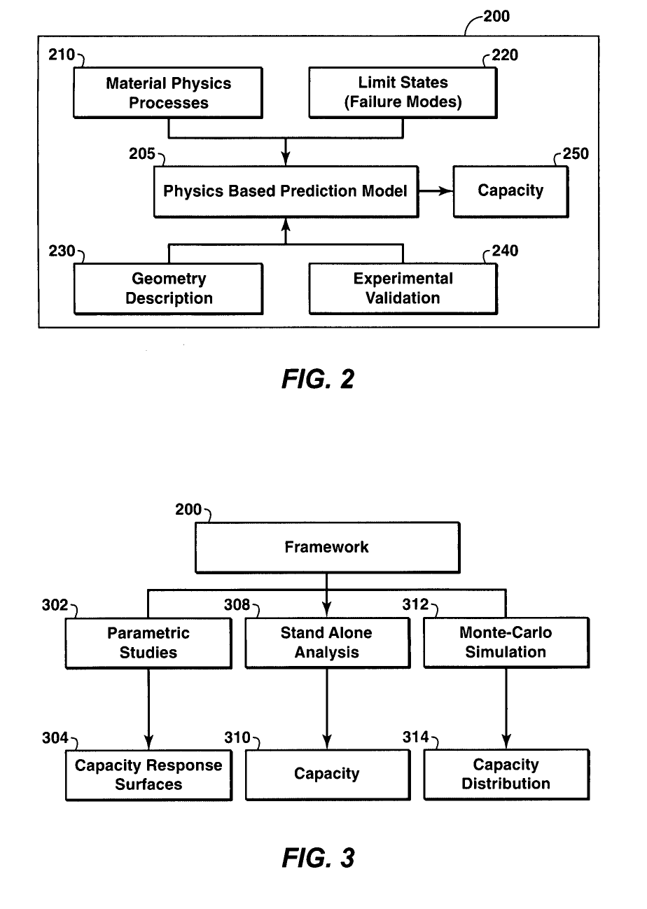

FIG. 2 illustrates a schematic representation of an exemplary embodiment of certain aspects of the framework 200 of the present invention. The framework 200 includes a physics-based prediction model 205 built using inputs such as material physics processes 210, limit states 220, geometry descriptions 230, and selected experimental data sets 240 for validation of the physics-based model 205, to produce the capacity of a structure 250 (e.g. a tubular or welded pipeline). Note that an experimental validation 240 is preferably only used for selected data sets, not all data sets.

The material physics processes (or responses) 210 may include, for example, ductile tearing, brittle fracture, elastic response, plastic response, dislocation movements controlling plastic response, corrosion response, and atomic interactions governing fracture, and any combination thereof. The limit states or failure modes 220 may include, for example, collapse, tensile fracture, buckling, material loss due to corrosion, and any combination thereof. The framework 200 may be used to determine or predict a capacity 250 associated with each limit state 220. Further, there may be multiple limit states 220, but only one dominant limit state 220. The dominant limit state 220 may also be referred to as the “governing” limit state 220 because the determined or predicted capacity 250 is preferably governed by the dominant limit state 220. Tensile fracture strain capacity 250, for example, may be induced by application of a variety of limit states 220, such as tensile loads, bending loads, torsion loads, and any combination thereof. These loads may be caused by seismic induced fault movements, permafrost heave or thaw, thermal loads, careless digging, or other incursions. The geometry description 230 may include, for example, weld geometry, structure geometry, flaw geometry, flaw location, or any combination thereof. For a pipeline, some exemplary elements include, but are not limited to pipe outer diameter, wall thickness, pipe ovality, weld misalignment, flaw length, flaw depth, and local wall thickness reduction due to corrosion and dents or gouges in the pipe body.

One example of multiple limit states 220 is a pipe body 100 placed under a bending load. The bending load places the top surface of the pipe body 100 in tension and the bottom surface of the pipe body 100 in compression. As such, at least two limit states 220 (a tensile fracture limit state 220 to account for the tensile strains and a buckling limit state 220 to account for the strain caused by compression) are activated in the framework 200 to predict the capacity 250 of the pipe body 100. Corresponding to the tensile limit state 220 various material physics processes 210 are activated, such as, for example, brittle fracture, ductile fracture, elastic and plastic response. Corresponding to the buckling limit state 220 various other material physics processes 210 are activated, such as, for example, elastic and plastic response. The two limit states 220 compete with each other until one limit state 220 dominates and causes the pipe body 100 to lose the ability to carry a load. For example, if the buckling limit state 220 dominates the pipe fails due to the formation of a buckle and if the tensile limit state dominates the pipe fails due to either brittle failure or ductile failure.

The framework 200 allows activation of at least one material physics process 210, at least one limit state 220, and at least one geometry description 230, or allows selection of subsets thereof. The material physics processes 210, limit states 220, and geometry descriptions 230 may be incorporated explicitly into the physics based prediction model 205. Activating a material physics process 210 means including at least one material physics process 210 in the analysis to predict capacity 250. In cases where more than one material physics process 210 is activated, the onset and progression of the specific material physics processes 210 governing structural response are captured by the physics-based model 205. For example, if “ductile tearing” is activated, the physics based prediction model 205 utilizing the material physics process 210 predicts the onset of ductile tearing and the progression of the ductile tearing. The ductile tearing process may control the structural response, or another competing material physical process 210 (such as plasticity) may determine the structural response. Eventually, one of the material physical processes 210 controls the structural response and causes failure. The strain capacity 250 is then defined based on the predicted structural response. Strain capacity 250 may be defined in any manner and may be selected by the user. One exemplary definition of strain capacity 250 is the strain at which maximum load is achieved. However, other definitions may be used, including, for example, the strain at which stable ductile tearing initiates or the strain at which unstable ductile tearing initiates.

Experimental validation 240 may then be used to quantify the accuracy of the capacity prediction(s) 250. The number and type of validation tests used to quantify the accuracy of predictions is termed as selected data sets. Examples of validation tests may include, but is not limited to, a curved wide plate specimen or a full-scale pressurized (or unpressurized) pipe test. Multiple measures may be used to determine the accuracy of the physics based prediction model 205. These include, for example: a comparison of the predicted strain at maximum load versus the measured strain at maximum load or the predicted strain at the onset of crack growth versus the measured strain at the onset of crack growth or the predicted crack growth rate versus the measured crack growth rate or the predicted surface strain versus the measured surface strain. The direct comparison of the prediction(s) 250 versus the respective selected data sets of the experimental validation 240 may be used to quantify errors or improve physics-based prediction model(s) 205. Upon completing successful experimental validation 240 of the physics-based model 205 against selected data sets, subsequent predictions with the framework 200 do not require a separate validation 240. In one embodiment of the present invention, a limited set of selected validation tests 240 are conducted, for example, to show that the underlying physics are correctly captured in the prediction model 205. A validation test 240 may be required if additional material physical processes 210 are included or if a prediction of new materials not previously considered is conducted.

The physics-based prediction model 205 may comprise any method used to solve differential equations governing structural responses of interest, including, but not limited to finite element methods, finite difference methods, element-free methods, which incorporate a constitutive model such as, a tearing resistance curve, a model including crack initiation and propagation, including but not limited to a Gurson Model, cohesive finite elements, atomistic models, ab inito models, virtual crack closure models, or any other constitutive model for predicting the onset and/or progression of material damage. One example of a physics based prediction model 205 is a finite element analysis (FEA) using constitutive descriptions that approximate the underlying material physical processes 210.

The descriptions approximating the underlying material physical processes 210 may be obtained by a variety of methods or processes, including experimental methods, numerical simulations, or provided by a database of data sets. One method may comprise, for example running physical tests to determine appropriate ranges, then running a numerical approximation using those inputs, then calibrating the ranges using additional results from small scale testing. In one example, experimental characterization test may be used to determine the underlying material physical processes 210 to develop the material response constitutive models that are embedded within physics-based prediction model 205 or to determine the parameters defined within the constitutive models to describe material response embedded within physics-based prediction model 205. Some examples of experimental methods used to characterize or develop the input parameters for the material response constitutive models used in the physics-based prediction model 205 include, but are not limited to small scale testing methods to measure fracture parameters (see Corigliano, et al. infra), cohesive zone models (see Cornec, et al. infra), and the use of small scale punch tests to determine damage parameters for Gurson type damage models (see Abdenroth, et al. infra), determining the true stress and true strain (see the '011 patent infra), flat bar tensile specimens to measure the material properties of welds (see Schwalbe, et al. infra), and full scale testing methods (see 2007EM086 infra). The experimental techniques include any method that can be used to understand the initiation and progression of material processes 210.

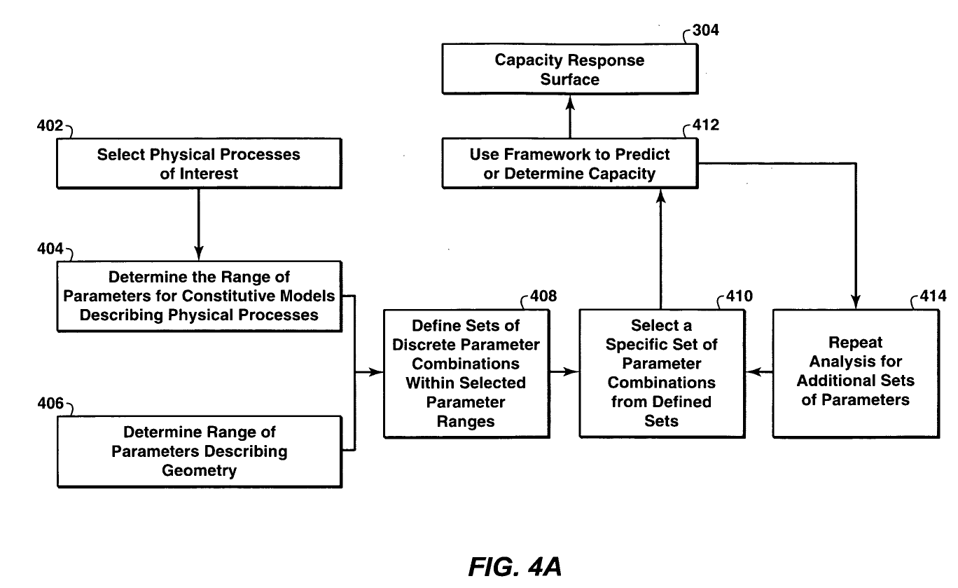

FIG. 3 is an illustration of a schematic representation of exemplary embodiments of certain aspects of utilizing the framework 200 of the present invention. As such, FIG. 3 may be best understood with reference to FIG. 2. The framework 200 may be utilized using parametric studies 302, a stand-alone design analysis 308, or a Monte-Carlo simulation 312. The parametric studies 302 are used to develop strain capacity predictive response surfaces 304. Note that the predictive response surfaces 304 are the capacity 250 obtained using a parametric study 302 method. The predictive response surfaces 304 may be included in a computer database, provided by an operator, provided over a network, or other source.

An alternative mode of using the framework 200 is a stand alone design analysis 308. In a stand-alone design analysis 308, the user may, for example, select parameters such as material parameters 210, limit states 220, and geometry descriptions 230 and uses the parameters as inputs to the framework 200 to determine the capacity 310 for the selected parameters. Note that the capacity 310 is the capacity 250 obtained using a stand-alone design analysis 308 method.

Another alternative mode of using the framework 200 is a Monte-Carlo simulation 312 to predict the capacity distribution 314. Note that the capacity distribution 314 is the capacity 250 obtained using a Monte-Carlo simulation 312. In a Monte-Carlo simulation 312, the user may, for example, provide the physics-based prediction model 205 with parameters governing material physics 210, limit states 220, and geometry descriptions 230 in the form of a distribution of values. The output is then a capacity distribution 314 rather than a single value.

A parametric study 302 designed using techniques know to those of skill in the art, such as “design of experiments,” can be conducted to develop a database of strain capacity values. This database may be used to develop capacity response surfaces 304, which can be employed as a surrogate to the framework 200 for strain capacity calculation. These response surfaces 304 may provide a computationally efficient option to understand the influence of key variables such as, but not limited to, weld geometry, pipeline geometry, flaw geometry, flaw location, material properties, and other input parameters employed by the framework 200.

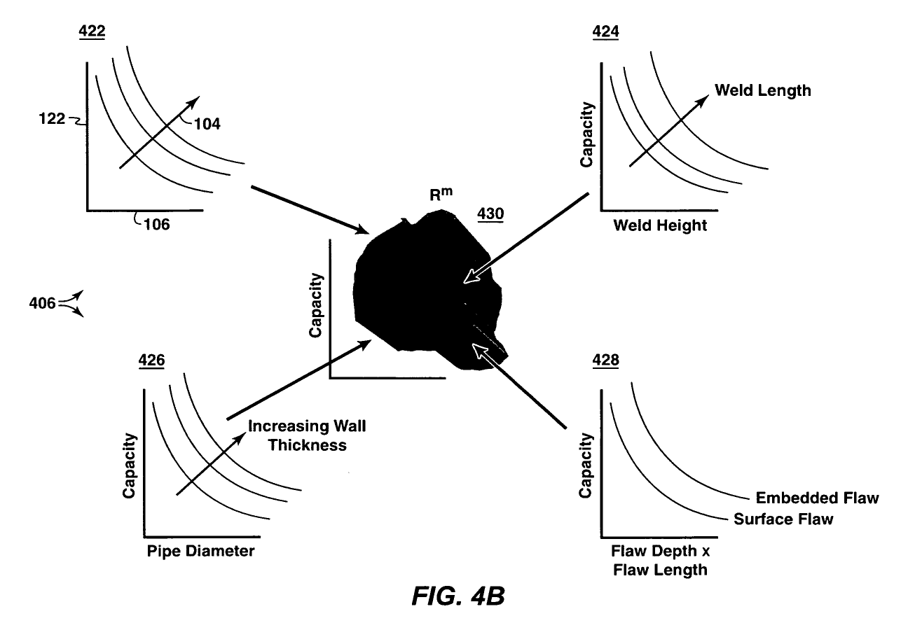

FIGS. 4A-4D are illustrations of an exemplary embodiment of certain aspects of the parametric study process 302, parameter inputs, and a capacity response surface made using FIGS. 2 and 3 of the present invention. Accordingly, FIGS. 4A-4D may be best understood by referencing FIGS. 2 and 3. In some embodiments of the parametric study method of the present invention, the underlying physics of the structural response are selected 402 from the material physics processes 210 and activated in the framework 200. The underlying physics 402 depends on the type of failure being solved for and may include one or more of ductile tearing, brittle fracture, plastic collapse, and buckling. An applicable range for each parameter considered in the framework 200 is pre-determined. The range of parameters for constitutive models in the physics-based model 205 describing material physical processes 210 may be determined 404 and a range of geometric parameters describing the geometry 230 may be determined 406. Then sets of discrete parameter combinations within selected parameter ranges may be defined 408. The range of discrete parameter values should span the pre-determined ranges 404, 406 of each parameter. Methods such as “design of experiments” can be used to define sets of discrete parameter combinations within selected parameter ranges 406 and 404. Then, a set of parameter combinations may be selected 410 from the defined sets 408. The selected set of parameter combinations 410 may then be used as inputs to the framework 200 to calculate capacity 412 for the selected set of parameter combinations 410. The computed capacity value may be recorded and the process repeated 414 for the next set of parameter combinations until a capacity value for each set of the parameter combinations 408 is calculated. A mathematical approximation, namely strain capacity response surface 304, is developed for the capacity data points recorded. The strain capacity response surface 304 is a function of parameters 404 and 406. A person of skill in the art will recognize that the calculated data points determine the form of mathematical approximation (e.g. linear, exponential, logarithmic, or other mathematical function).

FIGS. 4B-4C are illustrations of exemplary inputs for some embodiments of the parametric studies 302 of certain aspects of the present invention. Hence, FIGS. 4B-4C may be best understood with reference to FIG. 3. For example, one input may be the flaw geometry. The capacity as a function of flaw geometry may be determined from the parametric study by only considering a variation in the flaw height 104 and flaw length 106 to produce a response curve 422. Note, the illustrated response curve 422 may not represent the actual relationship between the parameters described herein and are only used to show that there is a functional relationship between the parameters shown. Other parametric sets may be chosen to analyze the influence of weld geometry 424, pipe geometry 426, flaw location 428, and/or other variables. It is then possible to construct a response surface 430 using the data points gathered by running the parametric study 302. As noted, the response surface 430 will be a function that best fits the data points and this best fit may be determined using any suitable method or system. The response surface 430 contains the influence of the geometric variables on capacity 304. This response surface 430 is a multi dimensional space of the order M.

Similarly, response curves 442, 444, 446, 448 for various material parameters can be constructed as shown in FIG. 4C and combined to produce a multi dimensional material response surface 450 of order N. Material parameters may also be referred to as “failure mechanisms” or “material physics,” 210 and comprise ductile tearing, brittle fracture, elastic response, plastic response, and any other process controlling the material response. The material and geometry response surfaces 430, 450 may be varied simultaneously to produce a capacity response surface 304 incorporating the influence of geometry and material variables as shown in FIG. 4D. This multi dimensional function 304 will be of the order of M+N. Note, that other capacity responses may be incorporated into this capacity response surface 304, so it is not strictly limited to the order of M+N.

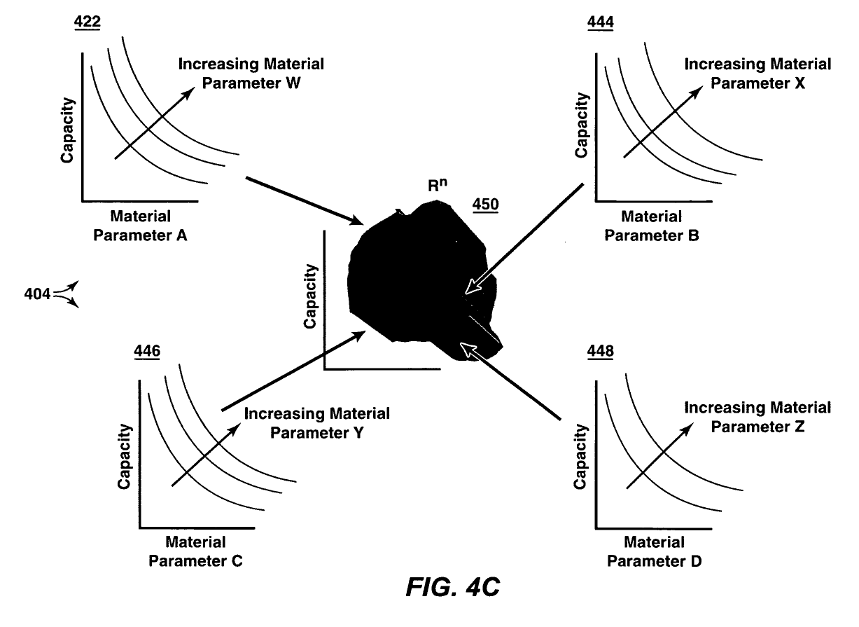

FIG. 5 is an illustration of a schematic representation for using the stand-alone strain capacity calculation of FIG. 3 of the framework of FIG. 2 of the present invention. Accordingly, FIG. 5 may be best understood by referring to FIGS. 2 and 3. In this mode, the relevant material physical processes 210 are selected 502, then a set of each constitutive model parameters describing physical processes 210 is determined 504 and a set of parameters describing the geometry is determined 505. The parameters 505 are then used as input to the framework 200 to predict or determine capacity 506 and the capacity is recorded 508. For example, this mode may be used to determine the capacity for an existing pipeline because many of the variables are already known and no range is necessary. In this case, a user may use in-field measurements to characterize the pipe and flaw geometry.

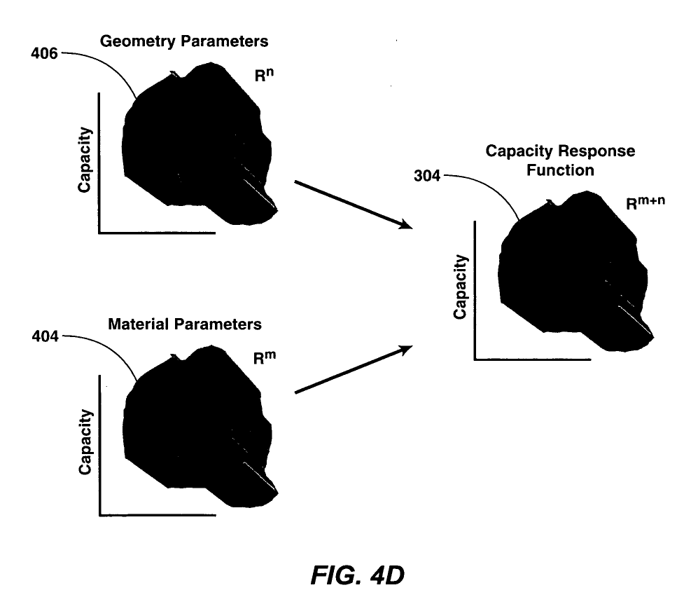

FIG. 6 illustrates a schematic representation of an exemplary embodiment of certain aspects of the Monte-Carlo process 312 of the present invention. As such, FIG. 5 may be best understood with reference to FIG. 3. The Monte-Carlo simulation 312 may be used to predict the capacity 250 of the structure. The method begins by a selection of the physical processes of interest 602. The distribution of parameters for constitutive models in 205 may be determined 603 and a distribution of geometric parameters describing the geometry may be determined 605. The distributions could be described by various statistical distribution functions and may be any type of distribution. Next, randomly select a set of parameter combinations 604 from each parameter distribution 603 and 605 to create a single set of randomly selected parameters that are used as input into the framework 200. A software tool may be developed to accomplish step 604 (discussed below). The framework 200 is used to predict the capacity 606. The capacity is recorded 608 and the process is repeated 610 by repeating the random selection of a new parameter combination set 604, prediction 606 and recording 608 of the capacity result. The process is repeated 610 until a statistically significant recording of capacity results is achieved to develop a capacity distribution 612 (e.g. capacity distribution 314). This mode may be used, for example, to determine capacity distributions for a reliability analysis as utilized by those of skill in the art.

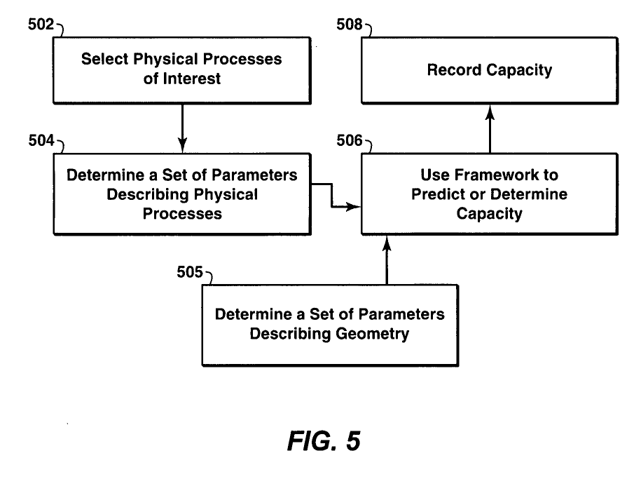

FIG. 7 is an illustration of a schematic representation of a capacity calculation software application 720 that may be developed based on the capacity response surfaces 304 and input from an end-user interface 722. Hence, FIG. 7 may be best understood with reference to FIG. 3. The user interface 722 is designed to allow input of various parameters (and reading of outputs if so desired), which may be the material physics 210, the geometry descriptions 230, and/or the limit states 220. The capacity calculation tool 724 is used to predict or determine the capacity using the capacity response surfaces 304. The capacity calculation software application 720 uses the input parameters 210, 220, or 230 to compute the capacity using the modes 302, 308, or 312. The algorithms for computing capacity may be based on the use of simple table look-up procedures or can be as complex as the use of numerical methods for solving response surfaces.

The capacity calculation software application 720 may be included in a computer database, provided by an operator, provided over a network, or other source. In one preferable embodiment, the user may not be a person of skill in the art, but may use the application 720 to obtain a capacity 250 of a structure in a short time frame, such as in about 10 minutes or less, or in about 1 minute or less, or in about 10 seconds or less. The application 720 may utilize the capacity response surfaces 304 obtained using the framework 200. For example, the user may be a project engineer at a site where a pipeline is being deployed and a design change is proposed, but the capacity of the newly designed pipeline has not been explicitly determined. In this case, the user can input the proposed pipeline parameters (material, geometry, welds, etc.) and retrieve a capacity based on the capacity response surfaces 304 in a short time frame.

The application 720 may be available on a laptop, personal computer, handheld device, or other processor-based device and may be capable of sending and/or receiving data over a wired or wireless network, satellite signal, cellular signal, or other means of transmission. The application 720 may be implemented as a spreadsheet, program, routine, software package, or additional computer readable software instructions in an existing program, which may be written in a computer programming language, such as Visual Basic, Fortran, C++, Java, XML, and the like. Of course; the processor-based device may include memory, such as hard disk drives, floppy disks, CD-ROMs and other optical media, magnetic tape, and the like, for storing the application. The processor-based device may include a monitor, keyboard, mouse and other user interfaces for interacting with a user. Results or outputs may be provided to a user via a display such as the end-user interface 722 or a report.

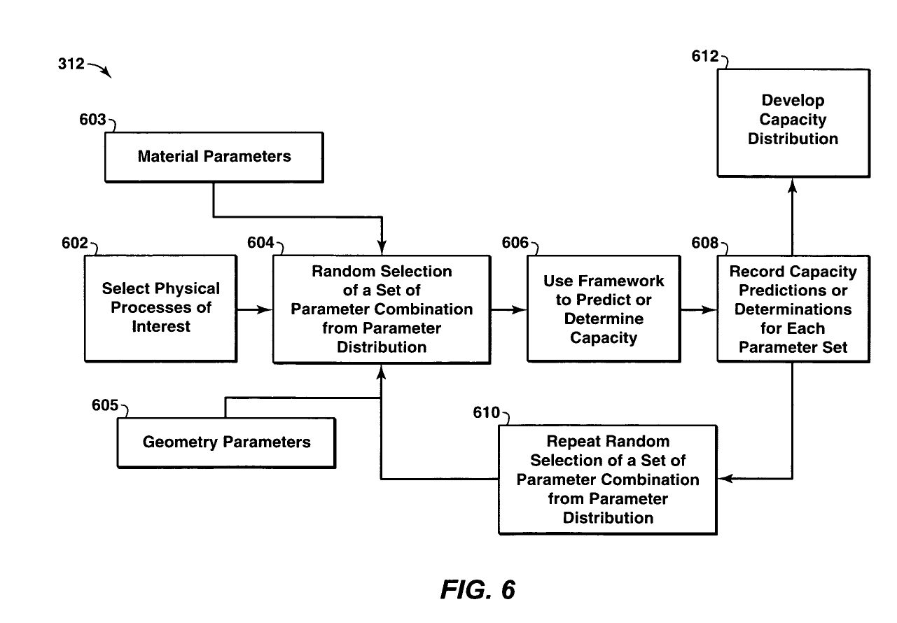

FIG. 8 is an illustration of a schematic representation of an automation software tool 820 to conduct the parametric studies 302, stand alone analysis 308, or the Monte-Carlo Simulation 312 using the framework 200. As such, FIG. 8 may be best understood with reference to FIGS. 2, 3. The user interface 824 is designed to allow input of various parameters 822 (and reading of outputs if so desired), which may be the material physics 210, the geometry descriptions 230, the limit states 220, and/or the validation 240. The user selects the mode of operation in the user interface 824, as one of parametric studies 302, stand alone analysis 308, or the Monte-Carlo Simulation 312. The parameters 822 may be defined sets of discrete parameter combinations determined using the process explained in FIG. 4 in steps 404, 406 and 408, a single set of parameters determined using the process explained in FIG. 5 in steps 504 and 505, or parameter distributions determined using the process explained in FIG. 6 in steps 603, 604, and 605 selected in user interface 824. An automation script 826 uses the defined parameters 822 based on the mode of operation as inputs into the framework 200 and produces the physics-based model 205 to compute the capacity 250. The capacity 250 may be any of the calculated response surfaces 304, strain capacity 310, or strain capacity distribution 314, depending on the user defined mode of operation selected in user interface 824.

The automation software tool 820 may be included in a computer database, provided by an operator, provided over a network, or other source. In one preferable embodiment, the user may be a person of ordinary skill in the art and may use the tool 820 to simply automate the process of computing parameter ranges and defining sets of discrete parameter combinations using those parameter ranges. The user is still responsible for selecting the material physical process 210, limit state 220, and geometry description 230 of interest, designing and defining the validation process, and making all necessary and proper adjustments to the automated script 826. For example, the user may be a pipeline researcher presented with a new design for a pipeline that does not fit any models or studies previously completed, such as a much larger or smaller pipeline, or one made using a different material or weld process that has not been used. In this case, the user selects the parameters of interest and runs the automated script 826, which drives the framework 200 to develop a predicted or determined capacity 250. The time and computing power needed to run the tool 820 would generally be greater than the time and computing power needed to calculate a specific capacity using the tool 720, which would reference a predetermined response curve 304.

The preferred processor-based device may be a mainframe computer, high-performance personal computer, or a node or network of processor-based devices working in combination and they may be capable of transmitting data to or from each other, a central database server, a local or wide area network, a virtual private network, or over the internet. The tool 820 may be implemented as a spreadsheet, program, routine, software package, or additional computer readable software instructions in an existing program, which may be written in a computer programming language, such as Visual Basic, Fortran, C++, Java, XML, and the like. Of course, the processor-based device may include memory, such as hard disk drives, floppy disks, CD-ROMs and other optical media, magnetic tape, and the like, for storing the application. The processor-based device may include a monitor, keyboard, mouse and other user interfaces for interacting with a user. Results or outputs may be provided to a user via a display such as the end-user interface 824 or a report.

In one exemplary embodiment of the framework 200 used in stand alone prediction mode 308 the user activates the following three material physics parameters 210 1) elastic response, 2) plastic response, and 3) ductile tearing; selects a tensile fracture limit state 220, and selects a finite element model of a pipe body with a flaw along with elastic, elasto-plastic, and tearing constitutive models for the physics based predictive model 205.

### EXPERIMENTAL RESULTS

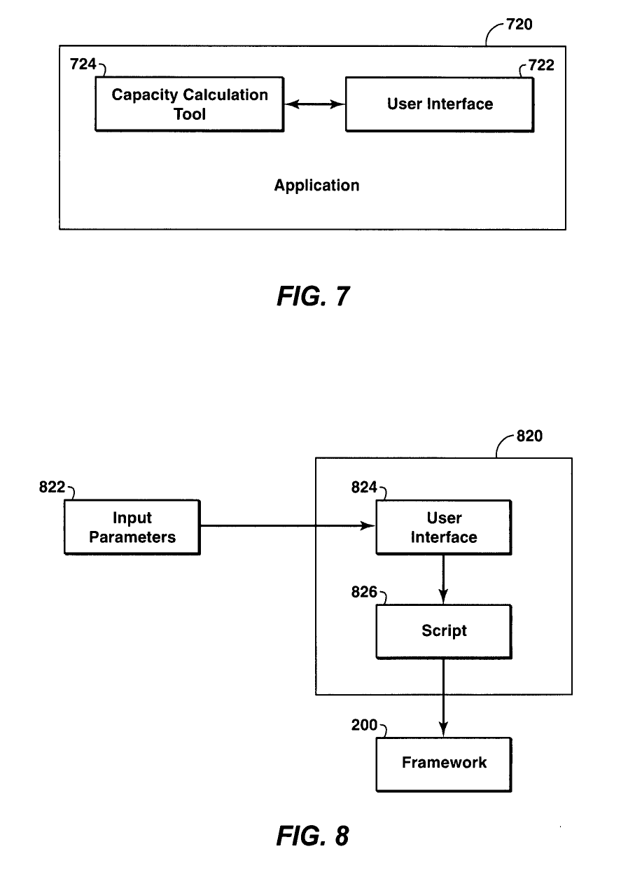

FIGS. 9A-9D show an exemplary experimental setup and results used to validate 240 the physics-based predictive model 205. FIG. 9A is a representation of the pipe body 100 and flaw geometry description 230, showing the radius of the pipe 108, length of the pipe 904, location of a weld 902 and location of a flaw 102. FIG. 9B illustrates an exemplary test setup schematic. This exemplary full-scale test comprises of placing a weld 902 between two 12-inch pipe segments, fixing one end 906 of the pipe 100, applying a tensile load 910 to an end-cap 908 at the other end of the pipe 100, and applying internal pressure 912. Applied load 910 and displacement were recorded in the full-scale test to measure failure load and calculate failure strain at maximum load. Strain was defined by measuring the change in length of the full-scale pipe body 100 divided by original length 904 of the pipe body 100 for a given level of applied load 910. However, other measures of strain known by those of skill in the art may be utilized.

At least one exemplary embodiment of the experimental validation 240 comprises conducting at least one full-scale test with a pipe body having at least one flaw. FIG. 9C is a representation of data points in a graph of crack tip opening displacement (CTOD) in millimeters (mm) 924 versus change in flaw height in mm 926. One set of data is for a pipe with no internal pressure 921 and the other set of data represents a pipe with high internal pressure 922. As is shown, there is not a significant difference between 921 and 922. The data points for the un-pressurized pipe are used to generate a resistance curve 920 for the tearing constitutive model. In this exemplary embodiment a 12 inch outer diameter plain pipe sample 100 containing surface breaking flaws 102 that is un-pressurized and pulled in tension to failure is used to measure the resistance curve 920. FIG. 9D represents stress in kilo-pounds per square inch (kips) 932 versus strain in percent (%) 934 of the pipe segment 100 tested in FIG. 9C. The test result is an elastic and plastic stress-strain curve 930. Strain 934 calculated at failure is the data set used for experimental validation 240 of the physics-based predictive model 205. In this exemplary experimental validation 240 a 12 inch outer diameter plain pipe sample containing surface breaking flaws pressurized to 80% of the material specified minimum yield (SMYS) and pulled in tension to failure resulting in a failure strain capacity of 1.8%.

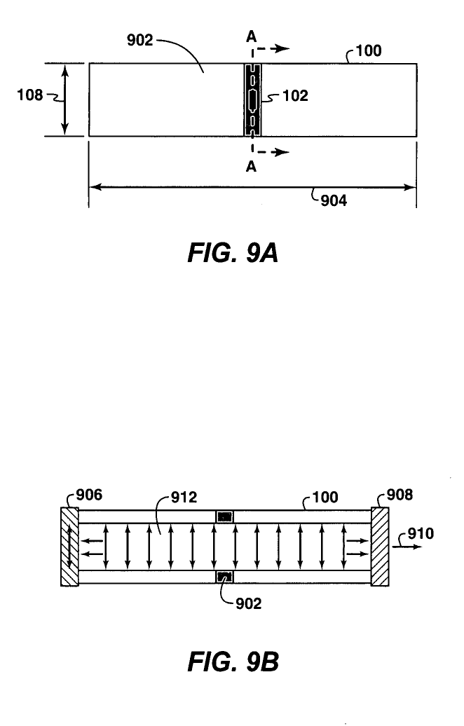

FIGS. 10A-10B illustrate graphical representations of driving force as a function of strain and change in crack size calculated using finite element analysis. FIG. 10A shows the predicted driving force 1006 as a function of applied strain 1008 for three different flaw lengths 1010a-1010c. In this exemplary embodiment driving force is defined as crack (or flaw) tip opening displacement (CTOD). FIG. 10B illustrates the driving force 1006 plotted versus flaw height 926 at three increasing levels of strain, namely, 1.4%, 1.6%, and 1.8%.

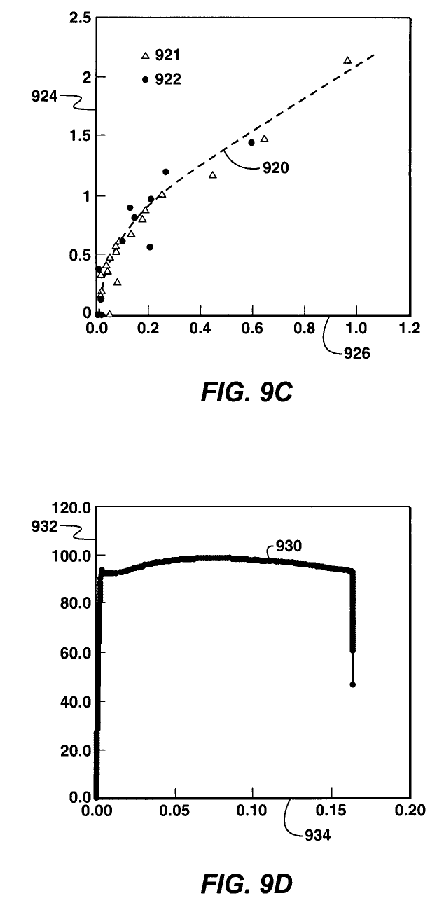

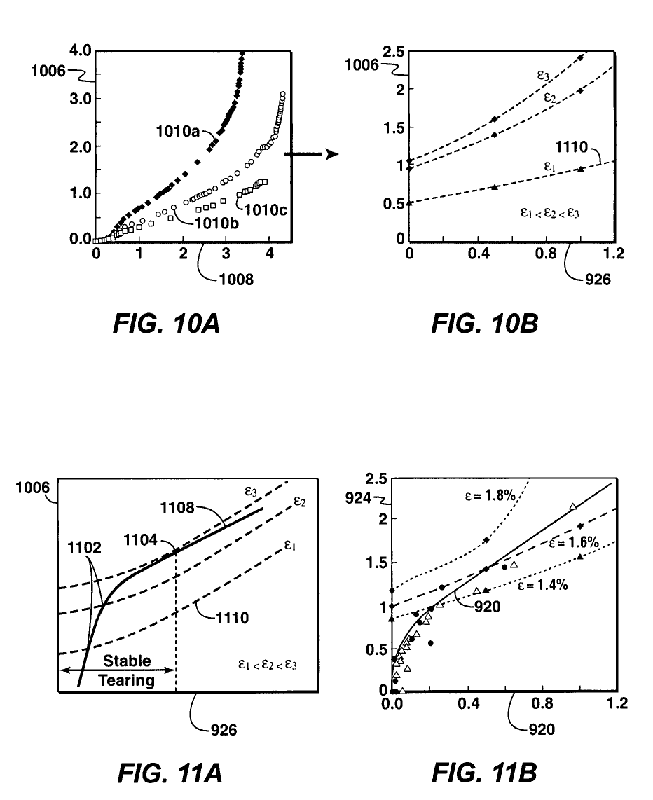

FIG. 11A illustrates a resistance curve 1108 overlaying a numerically calculated driving force data 1110 predicted from this embodiment of the physics-based prediction model 205 of FIG. 2. Accordingly, FIG. 11A may be best understood by concurrently viewing FIG. 2. The crack extension 926 remains stable as long as the driving force curve 1110 intersects the resistance curve 1108, such as at points 1102. However, as the global strain (ε₁-ε₃) increases, the driving force increases until the driving force curve 1110 becomes tangent to the resistance curve 1108, such as at point 1104. At this point of tangency 1104, the flaw will tear in an unstable manner and the structure fails. Strain capacity prediction in this embodiment is obtained by combining the predicted driving force data 1006 with the resistance curve 920 governing ductile tearing physics as shown in FIG. 1B. Note that the resistance curve 920 intersects the 1.6% strain driving force line, but doesn't quite touch the 1.8% driving force line, so the failure strain is between 1.6% and 1.8%. Thus the exemplary physics-based prediction model 205 predicts failure will occur between 1.6% and 1.8% strain as compared to experimental measured strain at failure of 1.8%. This validates the accuracy of the physics-based prediction model 205.

Although many of the problems addressed by the present invention relate to issues in the production of oil and gas via pipelines, the apparatuses and methods disclosed herein may be utilized to enable efficient designs of any structural body subjected to large scale yielding, whether or not the structural body includes portions bonded by welding or a any other joining technique.

While the present invention may be susceptible to various modifications and alternative forms, the exemplary embodiments discussed above have been shown by way of example. However, it should again be understood that the invention is not intended to be limited to the particular embodiments disclosed herein. Indeed, the present invention is to cover all modifications, equivalents, and alternatives falling within the spirit and scope of the invention as defined by the following appended claims.

What is claimed is:

1. A method of determining the capacity of a structure, comprising:
predicting the capacity of the structure utilizing a framework, wherein the framework comprises a physics-based prediction model, wherein the prediction model incorporates at least one material physics process, at least one geometry description, and at least one limit state; and
validating the predicted capacity of the structure.

2. The method of claim 1, wherein the structure is a pipeline having at least one pipe weld.

3. The method of claim 1, wherein the at least one material physics process comprises identification of at least one material physics process before a failure mechanism is initiated.

4. The method of claim 1, wherein the at least one material physics process comprises identification of at least one material physics process after a failure mechanism is initiated.

5. The method of claim 1, wherein the at least one material physics process comprises one of elastic response, ductile tearing, brittle fracture, plastic response, and any combination thereof.

6. The method of claim 1, wherein the at least one geometry description comprises one of weld geometry, structure geometry, flaw geometry, flaw location, and any combination thereof.

7. The method of claim 1, wherein the predicted capacity of the structure is validated utilizing an experimental verification process.

8. The method of claim 7, wherein the experimental verification process comprises calculating a capacity based on a limit state selected from the at least one limit state using a full scale testing specimen.

9. The method of claim 8, wherein the capacity is strain capacity.

10. The method of claim 9, wherein the capacity is tensile fracture strain capacity.

11. The method of claim 1, wherein the at least one limit state comprises a dominant limit state, and wherein the capacity is governed by the dominant limit state.

12. The method of claim 1, wherein the at least one material physics process is captured using a constitutive model.

13. The method of claim 12 wherein at least one experimental characterization test is used to determine at least one parameter of the constitutive model.

14. The method of claim 12, wherein the constitutive model is one of a Gurson model, cohesive zone model, and any combination thereof.

15. The method of claim 1, wherein the physics-based prediction model is one of a finite element analysis, a model including crack propagation, a finite difference model, element-free method analysis model, numerical models predicting physical processes, a Gurson model, cohesive finite elements, atomistic models, ab inito models, virtual crack closure models, and any combination thereof.

16. The method of claim 1, wherein the capacity is determined using one of a parametric study approach, a stand alone design analysis, and a Monte-Carlo simulation.

17. The method of claim 1, wherein the capacity is determined using a parametric study approach to develop at least one capacity response surface for use in a capacity calculation software application.

18. The method of claim 17, wherein the capacity calculation software application determines the capacity using one of the parametric study approach, a stand alone design analysis, and a Monte-Carlo simulation.

19. The method of claim 18, wherein the capacity calculation software application is implemented as computer readable software instructions, implemented on a processor-based device, and capable of sending and receiving data.

20. The method of claim 1, wherein the capacity is calculated using an automation software tool.

21. The method of claim 20, wherein the automation software tool produces the physics-based prediction model utilizing the at least one material physics process, the at least one geometry description, the at least one limit state, and the validation.

22. The method of claim 21, wherein the automation software tool is implemented as computer readable software instructions, implemented on a processor-based device, and capable of sending and receiving data.

23. A method of predicting the capacity of a structure, comprising:
providing a framework including a physics-based prediction model; and
incorporating at least one material physics process, at least one geometry description, and at least one limit state into the physics-based prediction model, wherein the framework is used to predict the capacity of the structure.

24. The method of claim 23, wherein the structure is a pipeline having at least one pipe weld.

25. The method of claim 23, wherein the at least one material physics process comprises identification of at least one material physics process before a failure mechanism is initiated.

26. The method of claim 23, wherein the at least one material physics process comprises identification of at least one material physics process after a failure mechanism is initiated.

27. The method of claim 23, wherein the at least one material physics process comprises one of elastic response, ductile tearing, brittle fracture, plastic response, and any combination thereof.

28. The method of claim 23, wherein the at least one geometry description comprises one of weld geometry, structure geometry, flaw geometry, flaw location, and any combination thereof.

29. The method of claim 23, wherein the predicted capacity is strain capacity.

30. The method of claim 29, wherein the predicted capacity is tensile fracture strain capacity.

31. The method of claim 23, wherein the at least one limit state comprises a dominant limit state, and wherein the predicted capacity is governed by the dominant limit state.

32. The method of claim 23, wherein the at least one material physics process is captured using a constitutive model and the at least one experimental characterization test is used to determine at least one parameter of the constitutive model.

33. The method of claim 23, wherein the predicted capacity is predicted using one of a parametric study approach, a stand alone design analysis, and a Monte-Carlo simulation.

34. The method of claim 23, wherein the predicted capacity is predicted using a parametric study approach to develop at least one capacity response surface for use in a capacity calculation software application.

35. The method of claim 34, wherein the capacity calculation software application predicts the predicted capacity using one of the parametric study approach, a stand alone design analysis, and a Monte-Carlo simulation.

36. The method of claim 23, wherein the predicted capacity is calculated using an automation software tool.

37. A method of producing hydrocarbons, comprising:
designing a pipeline for producing hydrocarbons, comprising:
determining the capacity of the pipeline, comprising:
predicting the capacity of the pipeline utilizing a framework, wherein the framework comprises a physics-based prediction model, and wherein the prediction model incorporates at least one material physics process, at least one geometry description, and at least one limit state; and
validating the predicted capacity of the pipeline; and
producing hydrocarbons utilizing the pipeline.

38. The method of claim 37, wherein the at least one failure mechanism comprises one of ductile tearing, brittle fracture, elastic response, plastic response, and any combination thereof.

39. The method of claim 37, wherein the predicted capacity of the pipeline is verified utilizing an experimental validation process.

40. The method of claim 37, wherein the at least one failure mechanism is captured using a numerical approximation tool.

41. The method of claim 37, wherein the physics-based model is one of finite elements and finite difference.

42. The method of claim 37, wherein the capacity is tensile fracture strain capacity.

43. The method of claim 37, wherein the at least one limit state comprises a dominant limit state, and wherein the capacity is governed by the dominant limit state.

44. The method of claim 37, wherein the at least one material physics process is captured using a constitutive model and the at least one experimental characterization test is used to determine at least one parameter of the constitutive model.

45. The method of claim 37, wherein the capacity is determined using one of a parametric study approach, a stand alone design analysis, and a Monte-Carlo simulation.

46. The method of claim 37, wherein the capacity is determined using a parametric study approach to develop at least one capacity response surface for use in a capacity calculation software application.

47. The method of claim 37, wherein the capacity is determined using an automation software tool.

48. A method of designing a structure, comprising:
determining a capacity of the structure, comprising:
predicting the capacity of the structure utilizing a framework, wherein the framework comprises a physics-based prediction model, wherein the prediction model incorporates at least one material physics process, at least one geometry description, and at least one limit state; and
validating the predicted capacity of the structure; and
designing the structure utilizing the determined capacity of the structure.

49. The method of claim 48, wherein the structure is a pipeline having at least one pipe weld.

50. The method of claim 48, wherein the at least one failure mechanism comprises one of ductile tearing, brittle fracture, elastic response, plastic response, and any combination thereof.

51. The method of claim 48, wherein the predicted capacity of the structure is verified utilizing an experimental validation process.

52. The method of claim 48, wherein the capacity is tensile fracture strain capacity.

53. The method of claim 48, wherein the at least one limit state comprises a dominant limit state, and wherein the capacity is governed by the dominant limit state.

54. The method of claim 48, wherein the at least one material physics process is captured using a constitutive model and the at least one experimental characterization test is used to determine at least one parameter of the constitutive model.

55. The method of claim 48, wherein the capacity is determined using one of a parametric study approach, a stand alone design analysis, and a Monte-Carlo simulation.

56. The method of claim 48, wherein the capacity is determined using a parametric study approach to develop at least one capacity response surface for use in a capacity calculation software application.

57. The method of claim 48, wherein the capacity is calculated using an automation software tool.

58. A structure, comprising:
a capacity, wherein the capacity of the structure is determined by:
predicting the capacity of the structure utilizing a framework, wherein the framework comprises a physics-based prediction model, wherein the prediction model incorporates at least one material physics process, at least one geometry description, and at least one limit state; and
validating the predicted capacity of the structure.

59. The structure of claim 58, wherein the structure is a pipeline having at least one pipe weld.

60. The structure of claim 58, wherein the at least one failure mechanism comprises one of ductile tearing, brittle fracture, elastic response, plastic response, and any combination thereof.

61. The structure of claim 58, wherein the predicted capacity of the structure is verified utilizing an experimental validation process.

62. The structure of claim 58, wherein the capacity is tensile fracture strain capacity.

63. The structure of claim 58, wherein the at least one limit state comprises a dominant limit state, and wherein the capacity is governed by the dominant limit state.

64. The structure of claim 58, wherein the at least one material physics process is captured using a constitutive model and the at least one experimental characterization test is used to determine at least one parameter of the constitutive model.

65. The structure of claim 58, wherein the capacity is determined using one of a parametric study approach, a stand alone design analysis, and a Monte-Carlo simulation.

66. The structure of claim 58, wherein the capacity is determined using a parametric study approach to develop at least one capacity response surface for use in a capacity calculation software application.

67. The structure of claim 58, wherein the capacity is calculated using an automation software tool.

68. An apparatus, comprising:
a processor; and
a memory coupled to the processor, wherein the processor is configured to execute computer readable instructions to:
predict the capacity of a structure utilizing a framework, wherein the framework comprises a physics-based prediction model, wherein the prediction model incorporates at least one material physics process, at least one geometry description, and at least one limit state.

69. The apparatus of claim 68, wherein the structure is a pipeline having at least one pipe weld.

70. The apparatus of claim 68, wherein the computer readable instructions comprise a capacity calculation software application.

71. The apparatus of claim 70, wherein the capacity calculation software application is configured to calculate the predicted capacity using a parametric study approach to develop at least one capacity response surface.

72. The apparatus of claim 71, wherein the apparatus is capable of sending and receiving data.

73. An apparatus, comprising:
a processor; and
a memory coupled to the processor, wherein the processor is configured to execute computer readable instructions to:
generate a physics-based prediction model utilizing at least one material physics process, at least one geometry description, at least one limit state, and at least one validation, wherein the physics-based prediction model is utilized in a framework for determining a capacity of a structure.

74. The apparatus of claim 73, wherein the computer readable instructions comprises an automation software tool.

75. The apparatus of claim 74, wherein the apparatus is capable of sending and receiving data.

76. The apparatus of claim 73, wherein the structure is a pipeline having at least one pipe weld.
